(19) United States
(12) Patent Application Publication
(10) Pub. No.: US 2020/0325076 A1
(43) Pub. Date: Oct. 15, 2020

(54) METHOD FOR MANUFACTURING A COMPOSITE MATERIAL PART PROVIDED WITH A SENSOR

(71) Applicant: SAFRAN CERAMICS, LE HAILLAN (FR)

(72) Inventors: Eric MARIAGE, MOISSY-CRAMAYEL (FR); Daniel BARRIERE, MOISSY-CRAMAYEL (FR); Rémi Pierre Robert BOUVIER, MOISSY-CRAMAYEL (FR)

(21) Appl. No.: 16/645,349

(22) PCT Filed: Sep. 6, 2018
(86) PCT No.: PCT/FR2018/052184

§ 371 Date: Mar. 6, 2020

(30) Foreign Application Priority Data
Sep. 7, 2017 (FR) 1758254

(51) Int. Cl. C04B 35/80; B29C 70/68; C04B 35/628; G01K 7/02; G01K 1/14; F02K 9/97; F02K 1/00

(52) U.S. Cl. CPC C04B 35/80; B29C 70/68; C04B 35/62863; C04B 35/62884; C04B 35/62886; G01K 7/02; F05D 2230/53; F02K 9/97; F02K 1/00; C04B 2235/3826; C04B 2235/5252; C04B 2235/614; C04B 2235/616; G01K 1/14

(57) ABSTRACT

A method for manufacturing a composite material part provided with a measuring sensor, the method including assembly of a first consolidated or unconsolidated preform of the part to be obtained with a second preform of a holding member, co-densification of the first and second preforms thus assembled in order to obtain the composite material part provided with the holding member, and positioning of at least one sensor of a physical or chemical parameter in a housing defined by the holding member.

### BACKGROUND OF THE INVENTION

The invention relates to a method for manufacturing a composite material part provided with a sensor, in particular for aeronautical applications.

It is well known that composite material parts are instrumented with measuring sensors to determine the physical or chemical stresses to which these parts are subjected. Sensors are usually attached to one or more surfaces of the part by means of holding members. The measurements returned by the sensors then provide access to the real stresses seen by the part in operation, such as temperature, pressure or deformation of the part.

In practice, the holding members of the sensors are fixed to a surface of the part by means of a ceramic glue. The measuring sensors are then inserted into housings defined by the holding members. Such instrumentation must then be held on the part for several hundred hours.

However, when the part is subjected to high loads, e.g. severe vibratory stress, it is possible that some holding members may become detached from the underlying part to which they are attached. The detachment of these holding members can then lead to the loss of the measurements of the sensors that were previously housed in these devices. It would therefore be advisable to reinforce the holding members on the composite part in order to limit the potential risk of detachment of these devices.

### Subject Matter and Summary of the Invention

The purpose of the present invention is to improve the holding of measuring sensors on the surface of a composite material part.

For this purpose, the invention provides a method for manufacturing a composite material part provided with a sensor, the method comprising at least the following steps:
assembly of a first consolidated or unconsolidated preform of the part to be obtained with a second preform of a holding member,
co-densification of the first and second preforms thus assembled in order to obtain the composite material part provided with the holding member, and
positioning of at least one sensor for measuring a physical or chemical parameter in a housing defined by the holding member.

A preform is said to be in the consolidated state when it has undergone a consolidation stage during which its initial porosity has been partially filled by a deposition of a consolidation phase, this preform in the consolidated state retaining a residual porosity which may be wholly or partially filled during the subsequent co-densification stage. Various examples of consolidation methods are detailed below. A preform is said to be in the unconsolidated state when it does not have such a consolidation phase.

The assembly of the first and second preforms is intended to form, after co-densification, the fibrous reinforcement of a one-piece composite material structure, which includes the holding member. Advantageously, the co-densification of the preform of the part and the preform of the holding member allows a better adhesion of the holding member to the underlying part. This strengthens the hold of the measuring sensors on the part.

In an example embodiment of this method, the holding member comprises two parts forming legs connected to the part and located on either side of the housing, and a joining part closing the housing on the side opposite the part and connecting the legs.

In an example embodiment of this method, the holding member comprises two spaced holding elements located on either side of the housing, with the spacing between the two holding elements decreasing with distance from the part.

In example embodiment of this method, co-densification is achieved by chemical vapor infiltration.

In another example embodiment of this method, co-densification is carried out by a liquid process.

In an example embodiment of this method, a silicon carbide matrix is deposited in the porosity of the first and second preforms during co-densification.

In an example embodiment of this method, the sensor is a temperature sensor.

In example embodiment of this method, the part is a nozzle diverter.

### BRIEF DESCRIPTION OF THE DRAWINGS

Other features and advantages of the invention will be apparent from the following description of particular embodiments of the invention, given by way of non-limiting examples, with reference to the appended drawings, wherein:

FIGS. 1 to 4 illustrate the different steps of an example method according to the invention,

FIG. 5 shows a composite part equipped with sensors obtained by using another example method according to the invention,

FIG. 6 is a photograph of a part of a composite part provided with a holding member similar to that of FIG. 5,

FIG. 7 shows a diverter with holding members and measuring sensors made according to the invention.

### DETAILED DESCRIPTION OF EMBODIMENTS

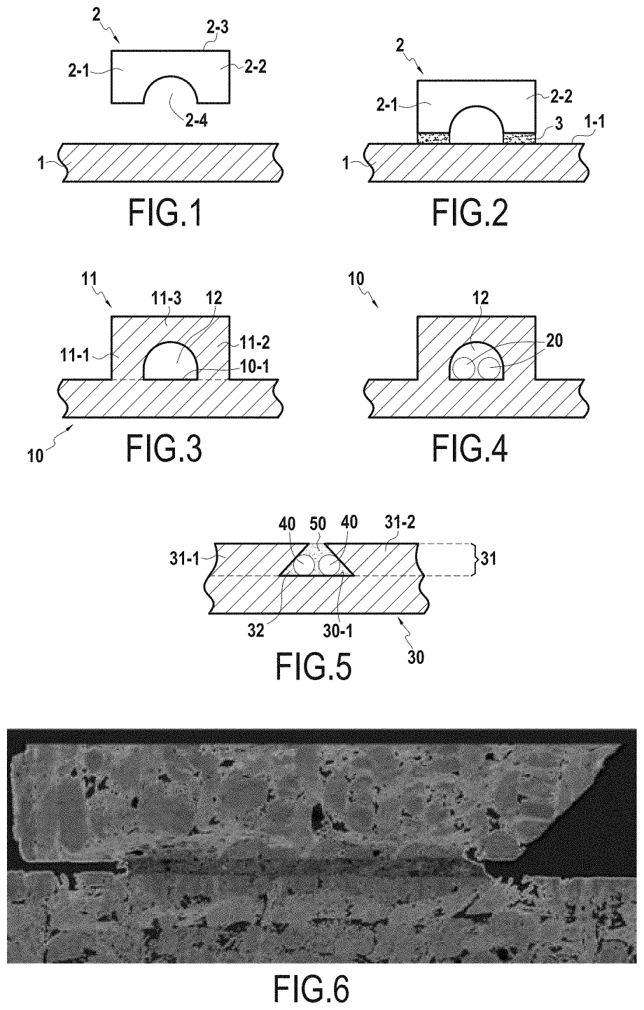

FIGS. 1 to 4 illustrate the different steps of manufacturing a composite material part intended to be instrumented by at least one measuring sensor.

FIG. 1 shows a first preform 1 of the composite material part to be manufactured and a second preform 2 of a holding member for holding at least one measuring sensor on the part to be manufactured.

The first preform 1 and the second preform 2 are fibrous preforms, each made by multilayer weaving between a plurality of layers of warp yarns and a plurality of layers of weft yarns.

The multilayer weave produced can be in particular an interlock weave, i.e. a weave in which each layer of weft threads binds several layers of warp yarns with all the yarns of the same weft column having the same movement in the plane of the weave. Alternatively, each layer of warp yarns binds several layers of weft yarns with all the yarns of the same warp column having the same movement in the plane of the weave, the roles between the warp and weft yarns being interchangeable.

Other types of multilayer weaving may be used. Different types of multilayer weaving that can be used are notably described in WO 2006/136755.

In an example embodiment, the first and second fibrous preforms 1, 2 can be formed from carbon yarns. Alternatively, the first and second fibrous preforms 1, 2 can be formed from ceramic yarns such as silicon carbide yarns.

Thus, in an example embodiment, the yarns used may be silicon carbide (SiC) yarns supplied under the name “Nicalon”, “Hi-Nicalon” or “Hi-Nicalon-S” by the Japanese company Nippon Carbon or “Tyranno SA3” by the company UBE and having for example a titer (number of filaments) of 0.5K (500 filaments).

In the example shown in FIGS. 1 to 4, the second preform 2 is made so that it has an arch or trigger guard profile. Specifically, the preform 2 of the holding member comprises two parts 2-1, 2-2 forming legs and a joining part 2-3 extending between the parts 2-1, 2-2. The parts 2-1, 2-2, 2-3 delimit a cavity 2-4. The cavity 2-4 is intended to form a housing for the reception of at least one measuring sensor once the holding member has been attached to the composite part.

After weaving, the first fibrous preform 1 can optionally, but not necessarily, be consolidated by depositing a consolidation phase in the porosity of the first preform 1, which consolidation phase can be deposited in a gas or liquid process in a manner known per se.

The liquid process consists of impregnating the preform with a liquid composition containing a precursor of the material of the consolidation phase. The precursor is usually in the form of a polymer, such as a resin, optionally diluted in a solvent. The preform is placed in a sealable mold. Then the mold is closed and the liquid precursor of the consolidation phase (for example a resin) is injected into the mold to impregnate the preform.

The transformation of the precursor in the consolidation phase is carried out by heat treatment, generally by heating the mold, after removal of any solvent and cross-linking of the polymer.

In the case of the formation of a consolidation phase in ceramic material, the heat treatment includes a step of pyrolysis of the precursor to form the consolidation phase in ceramic material. For example, liquid ceramic precursors, especially SiC, can be polycarbosilane (PCS) or polytitanocarbosilane (PTCS) or polysilazane (PSZ) resins. Several consecutive cycles, from impregnation to heat treatment, can be carried out to achieve the desired consolidation.

In the gas process (chemical vapor infiltration (CVI) of the consolidation phase), the fibrous preform is placed in a furnace in which a reactive gas phase is admitted. The pressure and temperature prevailing in the furnace and the composition of the gas phase are chosen so as to allow the diffusion of the gas phase within the porosity of the preform in order to form the consolidation phase there by depositing, at the core of the material in contact with the fibers, a solid material resulting from the decomposition of a constituent of the gas phase or from a reaction between several constituents.

The formation of a SiC consolidation phase can be achieved with methyltrichlorosilane (MTS) yielding SiC by decomposition of MTS.

Furthermore, the second preform 2 may or may not be consolidated before being assembled with the first preform 1.

The preforms 1, 2 are then joined together by superimposition, so that after co-densification they form the fiber reinforcement of a single-piece composite structure. In the example shown in FIG. 2, the parts 2-1, 2-2 forming legs of the second preform 2 and a surface 1-1 of the first preform 1 are joined together using an adhesive layer 3. This adhesive layer 3 is for example a graphite-based ceramic glue, for example the glue supplied under the name “Graphi-Bond™ 551-R” from AREMCO.

Once assembled together, the preforms 1, 2 undergo a co-densification step. A structure is obtained after co-densification in which the first and second preforms are densified and the parts forming legs 2-1 and 2-2 are attached to the underlying part by co-densification.

The co-densification of the first and second preforms 1, 2 can be achieved by a liquid process.

In a first example, liquid co-densification is achieved by melt infiltration. There is first introduction, into the porosity of the first and second assembled preforms 1, 2, of fillers, for example reactive fillers, the fillers being for example selected from SiC, Si₃N₄, C, B, and mixtures thereof. The introduction of the fillers may, for example, be carried out by slurry cast, by suction of sub-micron powders (APS) or by an injection process of the resin transfer molding (RTM) type in which a heat treatment is carried out after injection to evaporate the liquid medium.

Once the fillers have been introduced, the first and second preforms 1, 2 are then infiltrated with a melt infiltration composition comprising for example silicon to form a matrix co-densifying the first and second preforms 1 and 2. As shown in FIG. 3, this results in a composite part 10 with at least one holding member 11 forming a one-piece structure. The infiltration composition may consist of molten silicon or alternatively be in the form of a molten alloy of silicon and one or more other constituents. The constituent(s) present within the silicon alloy may be selected from B, Al, Mo, Ti, and mixtures thereof.

When reactive fillers are used, substantially all of the reactive fillers may be consumed during the reaction between the infiltration composition and the reactive fillers. Alternatively, only part of the reactive charge is consumed during this reaction.

In an example embodiment, the melt infiltration carried out can enable a matrix to be obtained by reaction between solid fillers, for example type C, SiC or Si₃N₄ introduced by slurry or prepreg, and a molten silicon-based alloy. The reaction can occur at a temperature of 1420° C. or higher. In view of the high temperatures involved, it may be advantageous for at least part of the first and second preforms to be made of heat-stable fibers, for example Hi-Nicalon or Hi-Nicalon S type.

The matrix formed by co-densification can be made of ceramic material or carbon.

In a second example, liquid co-densification is carried out by injecting and then polymerizing a resin in a similar way to what was mentioned above for consolidation. The polymerization step may possibly, but not necessarily, be followed by a pyrolysis step.

Alternatively, the co-densification of the first and second preforms 1, 2 can be carried out by chemical vapor infiltration in order to obtain the composite part 10 provided with the holding member 11. This type of process is carried out in a similar way to what was mentioned above for consolidation.

The yarns of the first and second preforms may, prior to co-densification, have been coated with an interphase layer, for example of PyC, BN or silicon-doped BN, and optionally with a carbide layer, for example of SIC or Si₃N₄.

Whichever co-densification process is chosen, the result is a one-piece structure of composite material with a profile corresponding to that of the assembly of the preforms 1, 2. The structure thus obtained consists of the part 10 with at least one holding member 11. In the example shown in FIG. 3, the holding member 11 is formed by two spaced legs 11-1, 11-2 joined by co-densification to the rest of structure 10, with the dotted lines symbolizing the junction between the legs 11-1, 11-2 and the rest of the structure 10. The legs 11-1, 11-2 as well as an area 10-1 of the part 10 extending between the legs 11-1, 11-2 delimit a housing 12. This housing 12 is closed on the opposite side to the part 10 by a junction part 11-3 connecting the legs 11-1, 11-2 to each other. At least one measuring sensor is then positioned in the housing 12 to measure a physical or chemical parameter of the part 10. By way of example, in FIG. 4, two sensors 20 are inserted in the housing 12, a higher or lower number of sensors can be considered. In addition, an adhesive (for example ceramic glue) may optionally, but not necessarily, be deposited in the remaining space of the housing 12 to limit any movement of the sensor(s) 20 that are already inserted in the housing 12.

FIG. 5 shows a variant embodiment of a holding member 31 attached to a composite material part 30. The holding member 31 is made by a similar process to that of the holding member 11, but unlike the holding member 11, the holding member 31 is made from two elementary preforms. The two elementary preforms of the holding member 31 have, by way of example, a bevel shape and are assembled on a surface of a first preform corresponding to the preform of the composite material part 30 to be manufactured. All of these preforms then undergo a co-densification step, as previously described, so as to obtain a single-piece structure formed from the composite material part 30 provided with at least one holding member 31.

In the example shown in FIG. 5, the resulting holding member 31 is formed from two holding elements 31-1, 31-2 spaced apart and bonded by co-densification to the part 30. The dotted lines here symbolize the junction between the holding elements 31-1, 31-2 and the rest of the part 30. The holding elements 31-1, 31-2 and a surface 30-1 of the part 30 extending between these elements delimit a housing 32.

At least one measuring sensor is then inserted in the housing 32. Thus, in the example shown, two measuring sensors 40 are inserted in the housing 32. Furthermore, in order to secure the holding of the sensors 40 present in the housing 32, the spacing between the holding elements 31-1, 31-2 is made to decrease with distance from the part 30. Thus, in the example shown, each holding element 31-1, 31-2 is made to have a beveled shape, with the bevels moving closer together with distance from the part 30.

In addition, in order to limit the movements of the measuring sensors 40 positioned in the housing 32, an adhesive 50, for example ceramic glue, can optionally, but not necessarily, be deposited in the housing 32 so as to fill the residual space between the two holding elements 31-1, 31-2 and the surface 30-1.

FIG. 6 shows a photograph of a part of a composite material part comprising a holding element 31-1 or 31-2 constituting the holding member 31. This part was obtained by co-densification of an elementary preform of the holding member 31 with a preform of the composite part 30. As can be observed, there is co-infiltration between the holding element and the underlying surface, thus improving the hold of the holding member on the composite part compared with the prior art.

Two plates provided with holding members 11, 31 and made of the same composite material, here carbon fiber reinforced carbon (C/C), were manufactured according to the previously described process for mechanical testing. A first plate, referred to below as “Plate No. 1” was directly subjected to shear forces exerted by mechanical testing means. A second plate, manufactured in a similar manner to plate No. 1 and referred to below as “plate No. 2” was subjected to thermal shock at 1400° C. and then underwent shear forces similar to those of plate No. 1. The shear stresses were applied in order to identify the thresholds leading to the detachment of the holding members 11, 31 of Plates No. 1 and No. 2. The table below gives the values of the rupture thresholds that were measured to obtain the pull-out of the holding members 11, 31 of Plates No. 1 and No. 2.

| | Test conditions | Shear force (daN) |
|---|---|---|
| Holding | Plate No. 1 | 43 |
| member 11 | Plate No. 2 | 44 |
| Holding | Plate No. 1 | 59.5 |
| member 31 | Plate No. 2 | 50 |

In general, it can be observed that the application of thermal shock to Plate No. 2 had a small impact on the measured thresholds compared to Plate No. 1, which did not undergo such thermal shock. In addition, the holding members 11 and 31 have a very satisfactory shear strength. Indeed, the shear forces required to pull out the holding members 11, 31 from Plates No. 1 and No. 2 are about ten times higher than thresholds measured in the past for which sensor holding members were fixed to a plate by means of a ceramic glue. Furthermore, it can be observed that the holding members 31 seem to have an even better shear strength than the holding members 11, which already have a very high shear strength. Thus, the results obtained confirm that the manufacture of a composite material part provided with at least one holding member, obtained by co-densification of a preform of the part with at least one preform of a holding member, considerably improves the strength of the holding member or members secured to the composite part.

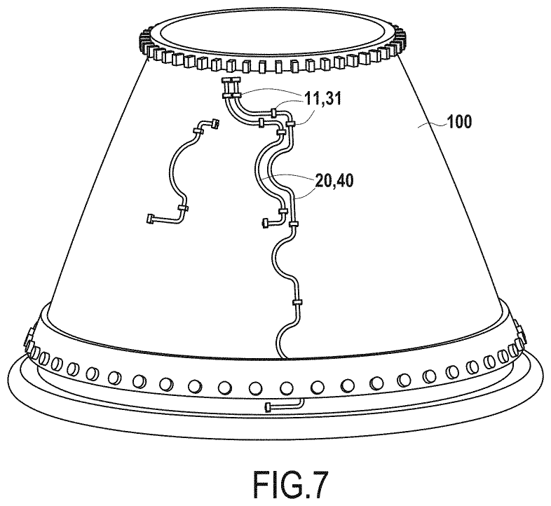

As shown in FIG. 7, the method described above can notably be applied to a nozzle diverter 100. Nevertheless, this method is applicable to any other composite part, for example an aircraft casing. The divergent 100 shown here is a composite material part provided with a plurality of holding members 11, 31 into which one or more measuring sensors 20, 40 are inserted. The measuring sensors 20, 40 are for example temperature sensors, for example thermocouples. However, any other type of sensor for measuring the composite part can be used, for example a pressure or deformation sensor.

1. A method for manufacturing a composite material part provided with a sensor, the method comprising:
assembling a first consolidated or unconsolidated preform of the part to be obtained with a second preform of a holding member,
performing a co-densification of the first and second preforms thus assembled in order to obtain the composite material part provided with the holding member, and
positioning of at least one sensor for measuring a physical or chemical parameter in a housing defined by the holding member.

2. The method as claimed in claim 1, wherein the holding member comprises two parts forming legs connected to the part and located on either side of the housing, and a joining portion closing the housing on the side opposite to the part and connecting the legs.

3. The method as claimed in claim 1, wherein the holding member comprises two holding elements located on either side of the housing, the spacing between the two holding elements decreasing with distance from the part.

4. The method as claimed in claim 1, wherein the co-densification is carried out by chemical vapor infiltration.

5. The method as claimed in claim 1, wherein the co-densification is carried out by a liquid process.

6. The method as claimed in claim 1, wherein a silicon carbide matrix is deposited in the porosity of the first and second preforms during co-densification.

7. The method as claimed in claim 1, wherein the sensor is a temperature sensor.

8. The method as claimed in claim 1, wherein the part is a nozzle diverter.
